(19) United States
(12) Patent Application Publication
(10) Pub. No.: US 2022/0270172 A1
(43) Pub. Date: Aug. 25, 2022

(54) Financial plan using event layers

(71) Applicant: Brian Charles Remington, Orlando, FL (US)

(72) Inventor: Brian Charles Remington, Orlando, FL (US)

(21) Appl. No.: 17/180,825

(22) Filed: Feb. 21, 2021

(51) Int. Cl. G06Q 40/06; G06F 16/28; G06F 3/0482

(52) U.S. Cl. CPC G06Q 40/06; G06F 16/287; G06F 3/0482

(57) ABSTRACT

A method of financial planning in which a financial model is created on a portable multifunction device. A financial database is created from User income, expenses, assets and liabilities and automated financial formulas are applied. Projects future cash flow and net worth.

Layered on the existing finances are future events. Each event applies changes to a future year or years and projects future cash flow and net worth impacts. Events can be added and deleted to allow User to assess impact of future financial decisions.

### FIELD

The present disclosure relates generally to computer user interfaces, and more specifically to techniques for developing a long term financial plan.

### BACKGROUND

Financial planning can be a long and expensive process. Part of the planning is obtaining customer information and part of the planning is applying financial formulas. For a complete long term financial plan, it involves complex calculations, rules, and future life event assumptions.

### BRIEF SUMMARY

Some techniques for developing a financial plan using electronic devices are generally limited in scope and inaccurate. For example, some existing techniques use simple financial formulas to project basic income, expense, assets and debt. Yet they ignore basic calculations on estimating state and federal taxes, estimating social security benefits, estimating future retirement account balances using employer contributions, payroll deductions to develop assets, and in general avoid real estate. Because they lack this insight, their plans offer a narrow view of the overall financial results do not accurately project whether a plan is realistic.

Additionally there are few plans that help project future events which have significant impact on a long term financial plan, such as retirement, child care, job changes, purchase or sale of real estate and vehicles, and many large one time expenses (i.e large medical bill, house repair, wedding, etc).

Each of the future events have very specific circumstances which need to be considered as they are included in an overall plan. As an example projecting a long term financial plan based on an existing salary and applying simple cost of living adjustments until a person retires is unrealistic. People generally have changes in their salary over their careers, such as a promotion and pay increase, to those who are out of work for a period of time. A job change may also impact expenses, such as higher costs for transportation for a longer commute.

Another future event example is child care, where a spouse may elect to take further time off from work without pay, or place a child in child care. This event could have a significant impact on cash flow due to changes in income and expense, and over the course of several years.

As electronic devices are available to many people, and the cost of a professional financial plan is out of reach for many people, there is an unmet need for a complete long term financial plan, on electronic devices, with significant automation of the complexities in developing an accurate plan.

### BRIEF DESCRIPTION OF DRAWINGS

There are five (5) drawings provided, three (3) which are flow charts of information, and two (2) figures.

FIG. 1—Is an outline of a portable multifunction device. Within this outline is the user interface elements to interact with. Selecting specific elements will allow further editing and insight of the financial data.

FIG. 2—Is an outline of a portable multifunction device. Within this outline is the user interface elements to represent event layers that are created with in the financial plan. Each event is represented in a timeline format and organized by time. Each layer can be edited and deleted within this view.

FIG. 3—Is a flowchart of how the information is collected and organized and stored for the base financial plan for the initial year.

FIG. 4—Is a flow chart of how the base finances are for updating existing financial data and the flow of information calculations and storage data.

FIG. 5—Is a flow chart of the event layers. This shows the organization of the layers and specific elements that are updated by the user to complete a layer. Each completed layer initiates a series of calculations to update the overall financial plan, and to update the user interface for data and graphical representation.

What is claimed is:

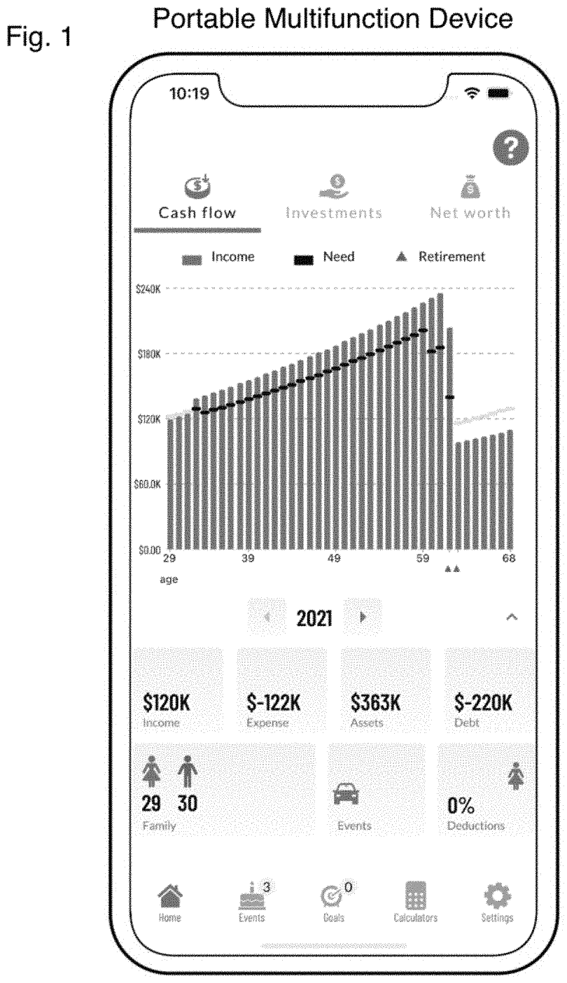

1. An electronic device using a program with instructions to develop a complete long term financial plan using a list of following claims, in its entirety, to provide a single completed view using a base set of finances and a series of future event layers (see FIG. 1). The combination of base and layers form a single financial estimate for each year of the financial plan model.

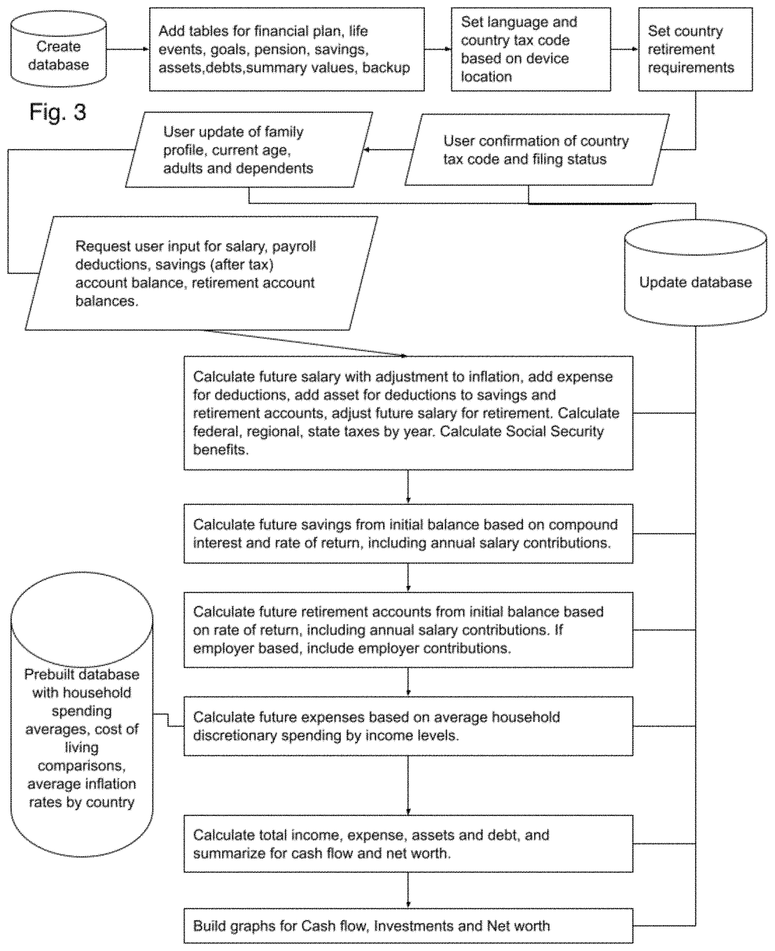

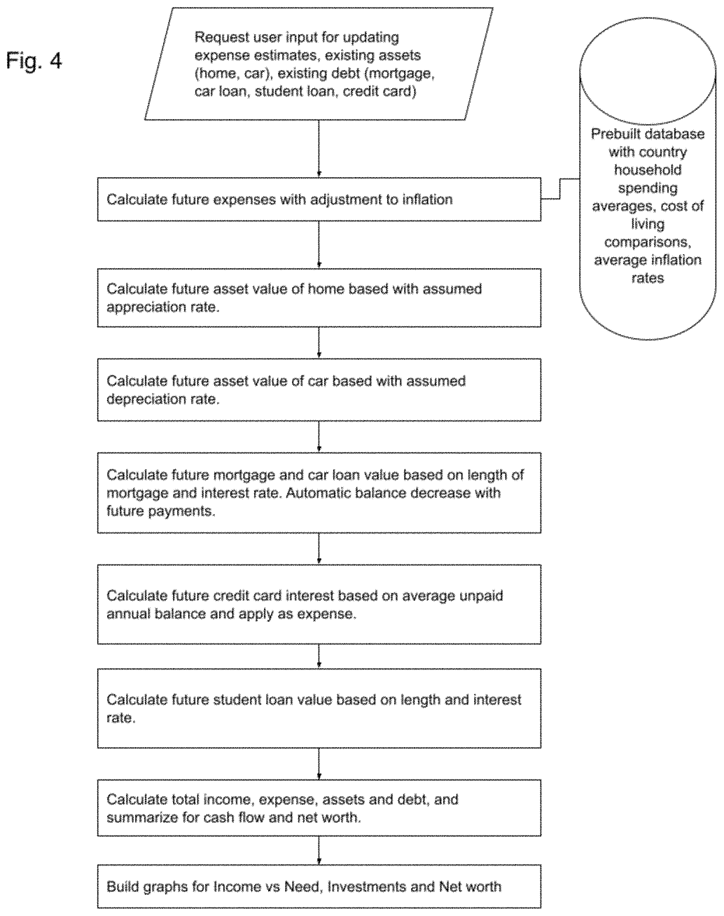

2. The program creates a base of finances for the initial year of the plan including:
(a) Gross salary (see FIG. 3)
(b) Estimates current state and federal taxes for expenses and adjusts future values based on inflation rates (see FIG. 3).
(c) Calculates payroll deductions for FICA withholding. This calculation is based on the current US guidelines for FICA withholding (medicare+social security) (see FIG. 3).
(d) Calculates expenses for payroll deductions for pre-tax and after-tax asset accounts. Annual deductions are applied to appropriate assets accounts. Pre-tax (retirement) accounts have further calculations based on employer contributions (see FIG. 3).
(e) Estimates social security benefits, based on income, and age to use benefits, along with projected future value based on inflation. Social security benefits can also be manually added. These estimates are based on the current SSA.GOV methodology for future benefits (see FIG. 3).
(f) Estimates initial expenses using average US household spending based on income levels (see FIG. 4).
(g) Calculates a purchased home's appreciation (see FIG. 4).
(h) Calculates a home loan (mortgage) yearly balance based on periodic payments based on interest (see FIG. 4).
(i) Calculates annual expenses for home loan payments (see FIG. 4).
(j) Calculates a purchased vehicle's depreciation (see FIG. 4).
(k) Calculates a vehicle loan yearly balance based on periodic payments based on interest (see FIG. 4).
(l) Calculates annual expenses for vehicle loan payments (see FIG. 4).
(m) Calculates credit card interest based on annual unpaid balances (see FIG. 4).
(n) Calculates compound interest of Savings (after-tax) accounts (see FIG. 4).
(o) Calculates annual expenses for student loan payments (see FIG. 4).
(p) Calculates a student loan yearly balance based on periodic payments based on interest (see FIG. 4).

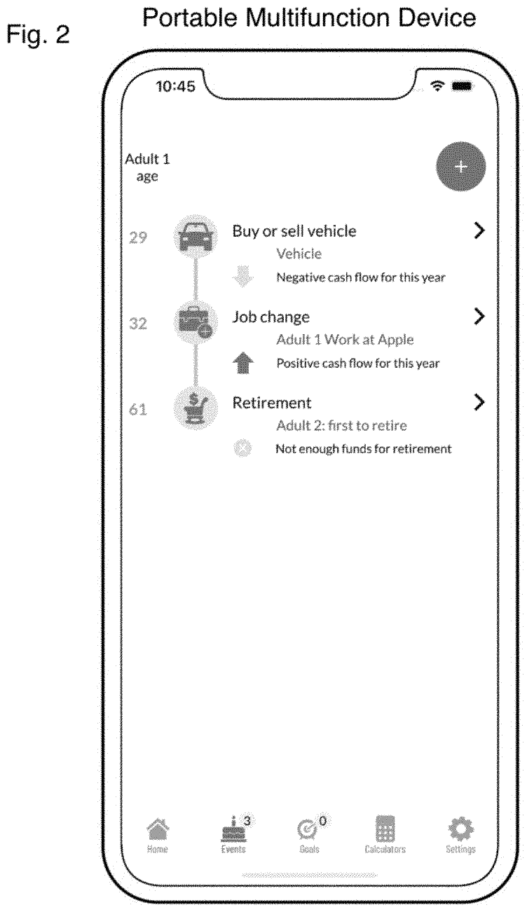

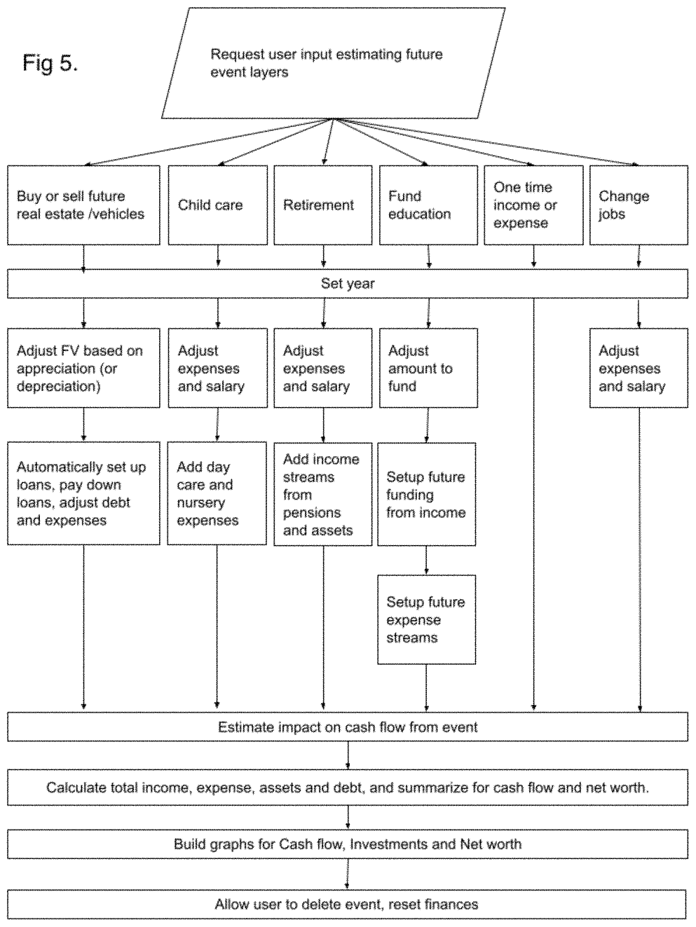

3. The series of future event layers include but are not limited to the following (see FIG. 2 and FIG. 5):
(a) Retirement
(a) The program calculates income streams from private pensions or rental income.
(b) The program calculates income streams from retirement accounts, based on amount to stream and start year. Penalties are estimated for income streams started for early withdrawals. Required minimum withdrawals are estimated.
(c) Calculates future retirement account balances based on contributions from employee and employer.
(d) Estimates retirement planning (future life event) based on year to start retirement, adjustable changes to overall expenses, changes to salary, start of state pensions (social security), and start of income streams from retirement accounts.
(b) Childcare
(a) The program estimates child care (future life event) based on year to start, changes to income, changes to expenses (i.e increase for healthcare, etc), expenses for daycare and nursery setup.
(c) Job change
(a) Estimates job changes based on year to start, changes to income, and potential changes to expenses (transportation, housing, clothing, healthcare).
(b) Job changes can be either change in compensation and/or change in employer
(d) Buy or sell real estate
(a) Estimates future purchase or sale of real estate.
(b) Selling estimates any assumed equity and applies to Savings.
(c) Purchase estimating includes monthly payment calculations including taxes and insurance, interest rate, and loan term length.
(e) Buy or sell vehicles
(a) The program estimates future purchase or sale of vehicles.
(f) Funding education
(a) Estimates any future funding education, such as college or private schooling.
(b) This includes average costs of various annual tuition, room and board, User selection of amount to fund, when to apply funds, estimation of annual expense, draw down of funding at the time of need, and calculation of future asset growth.
(g) One time income
(a) Calculates multiple future one-time income, such as a bonus, commission, inheritance, etc by year.
(h) One time expenses
(a) Calculates multiple future one-time expenses, such as a large medical bill, major house repair, vacation, wedding, etc, by year.
